(19) United States
(12) Patent Application Publication
(10) Pub. No.: US 2012/0068854 A1
(43) Pub. Date: Mar. 22, 2012

(54) SYSTEM AND METHOD FOR PROGRAMMING AND MONITORING ENERGY USE AND COST

(76) Inventors: Eric M. Shiflet, Boulder, CO (US); Dennis Kyle, Superior, CO (US); Scott S. Ballantyne, Morgan Hill, CA (US); Gowrishankar Bharadwaj, Commerce City, CO (US)

(21) Appl. No.: 13/053,064

(22) Filed: Mar. 21, 2011

Related U.S. Application Data
(60) Provisional application No. 61/315,839, filed on Mar. 19, 2010.

(51) Int. Cl. G08C 19/00

(52) U.S. Cl. 340/870.02

(57) ABSTRACT

The present invention can provide a method, apparatus, and system for providing energy usage information to a user. One embodiment displays, on a display interface of a display device, a virtual analog clock and receives energy usage data for a metered environment. A graphical representation of a first level of the energy usage data is displayed on the face of the virtual analog clock, with the graphical representation including at least one display element.

### PRIORITY

The present application claims priority from commonly owned and assigned U.S. Provisional Application No. 61/315,839, filed on Mar. 19, 2010, entitled “System and Method for Programming and Monitoring Energy Use and Cost,” which is incorporated herein by reference in its entirety and for all purposes.

### FIELD OF THE INVENTION

The present invention relates generally to energy-use monitoring devices. In particular, but not by way of limitation, the present invention relates to methods and devices for programming and monitoring energy usage within a metered environment.

### BACKGROUND OF THE INVENTION

Energy conservation has become increasingly important to consumers. One of the primary areas where consumers seek to conserve energy and reduce their expenses is household energy. Similarly, those responsible for energy consumption in small commercial settings are interested in reducing energy consumption and expenses. Traditional measuring devices for energy consumption include electricity and gas meters. However, these meters have not typically been in the conscience of the small energy consumer. Indeed, the consumer has traditionally only interacted with their energy provider through the billing process. But that interaction encompassed only a once-a-billing-period snapshot of energy consumption. As well, the consumer had control only through a thermostat to set indoor temperature and turning appliances either on or off. The consumer's energy consumption control was independent of both other consumers' energy consumption and the energy provider's ability to service its customers.

As energy conservation has gained a foothold in the public conscience, a greater need developed to control an environment's energy consumption. Programmable thermostats were developed, allowing consumers to automatically regulate heating and cooling of the environment. However, as these devices have become more complex, they have also become larger and, potentially, less aesthetically pleasing. Undoubtedly, they have assisted consumers in conserving energy. But those devices still did not offer the ability to holistically control energy consumption of the entire environment. A need for greater and more far-reaching control remained.

Smarter displays were developed, along with smart electricity grids, which allowed consumers to have richer interaction with energy providers. The interaction became ongoing, with the period billing becoming almost an afterthought. Those devices also provided much greater control of the energy consumption, down to the appliance level. But along with greater control came larger devices that could become unwieldy and more difficult to use. As a result, a need has arisen for a smart energy device with a more potent interface.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents, and alternative constructions that fall within the spirit and scope of the invention.

The present invention can provide a method, apparatus, and system for providing energy usage information to a user. One embodiment displays, on a display interface of a display device, a virtual analog clock and receives energy usage data for a metered environment. A graphical representation of a first level of the energy usage data is displayed on the face of the virtual analog clock, with the graphical representation including at least one display element.

Another illustrative embodiment is an apparatus, comprising a processor, a network interface to receive energy usage data for a metered environment, and a display interface. The display interface is used to display a virtual analog clock and a graphical representation of a first level of the energy usage data for the metered environment. The graphical representation of the first level of the energy usage data is displayed on the face of the virtual analog clock and includes at least one display element.

Yet another illustrative embodiment is a system comprising a display device to display a virtual analog clock and a graphical representation of a first level of energy usage data of a metered environment. The display device includes at least one input port to accept the energy usage data for the metered environment. The graphical representation of the first level of the energy usage data is displayed on the face of the virtual analog clock and includes at least one display element. The system further comprises at least one metering device associated with a disaggregated circuit element. The at least one input port receives energy usage data for the disaggregated circuit element from the at least one metering device. And the first level of the energy usage data includes the energy usage data of the disaggregated circuit element.

These and other embodiments are described in more detail herein.

### BRIEF DESCRIPTION OF THE DRAWINGS

FIG. 1 shows a system including the energy provider, energy and information networks, and metered environments in accordance with an illustrative embodiment of the invention.

FIG. 1A shows a block diagram of the device in accordance with an illustrative embodiment of the invention.

FIG. 1B shows a flowchart of a particular method for presenting graphical representations of energy usage data to a user in accordance with an illustrative embodiment of the invention.

FIG. 1C shows a flowchart of a particular method for presenting graphical representations of energy usage data to a user in accordance with an illustrative embodiment of the invention.

FIG. 1C shows a flowchart of a particular method for presenting graphical representations of energy usage data to a user in accordance with an illustrative embodiment of the invention.

FIGS. 2-31 show exemplary versions of the display interface 210 of the device 200 in various passive and active states and presenting various types of energy usage information in accordance with illustrative embodiments of the invention.

FIG. 32 shows an exemplary version of the device 200 as a table-top display device in accordance with an illustrative embodiment of the invention.

### DETAILED DESCRIPTION

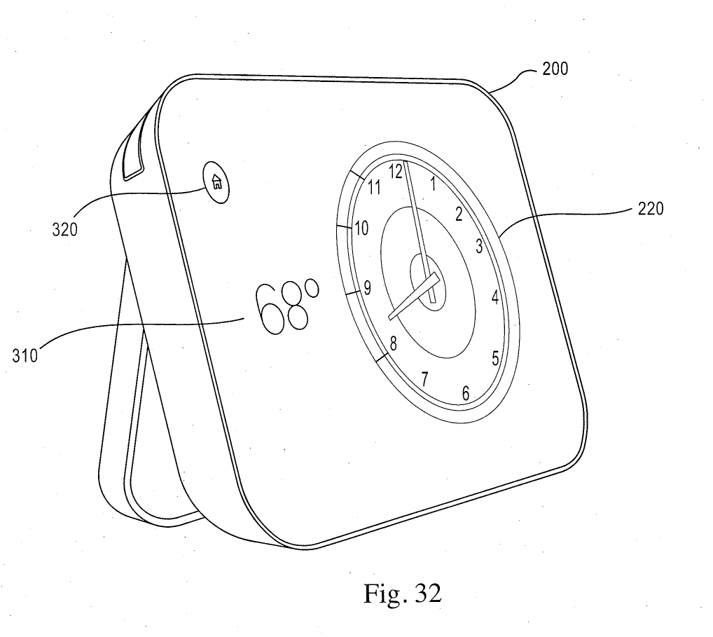

In one embodiment, the present invention can be implemented in a wall-mounted, graphical, touch screen user interface device used for reporting energy consumption to the user and allowing the user to program, monitor, and control their energy consumption. Other embodiments include a table-mounted unit as in FIG. 32. In yet other embodiments, user interaction may be implemented through a user interface other than a touch screen including, without limits, a mouse pointing device, remote device, audible (voice or other) commands, and motion/presence sensing. One of skill in the art understands that other methods of mounting the device and other methods of user interaction may be desirable.

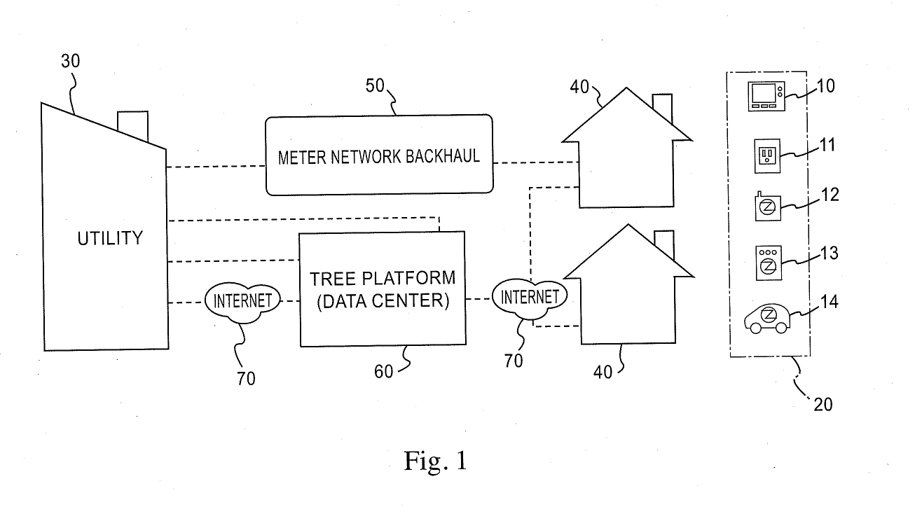

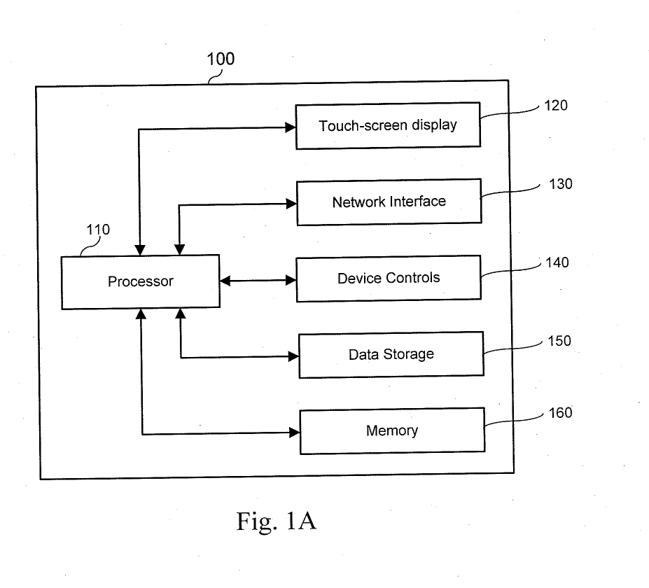

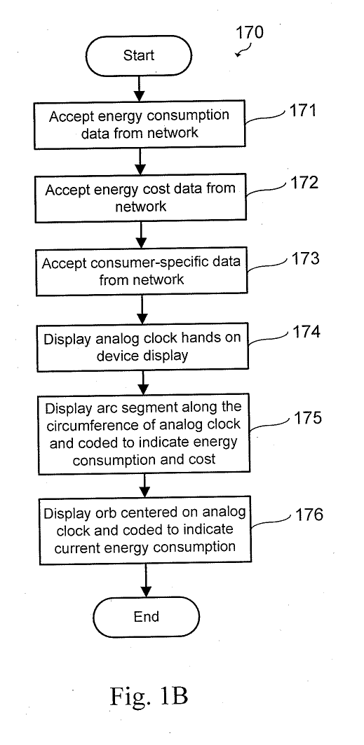

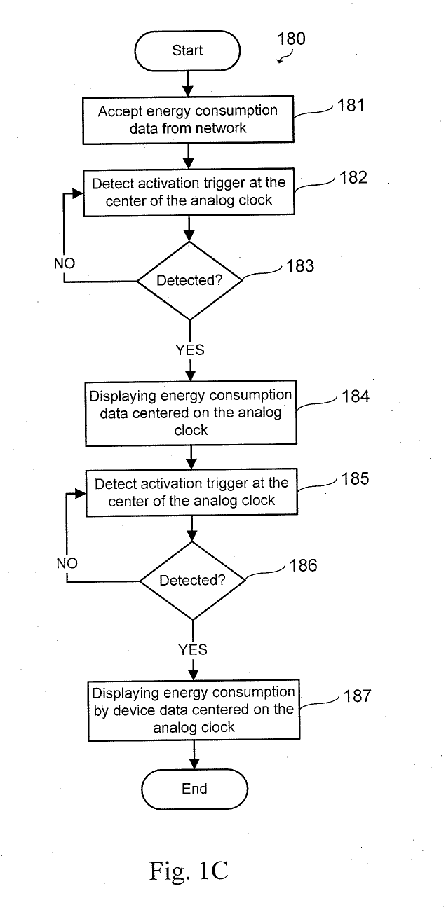

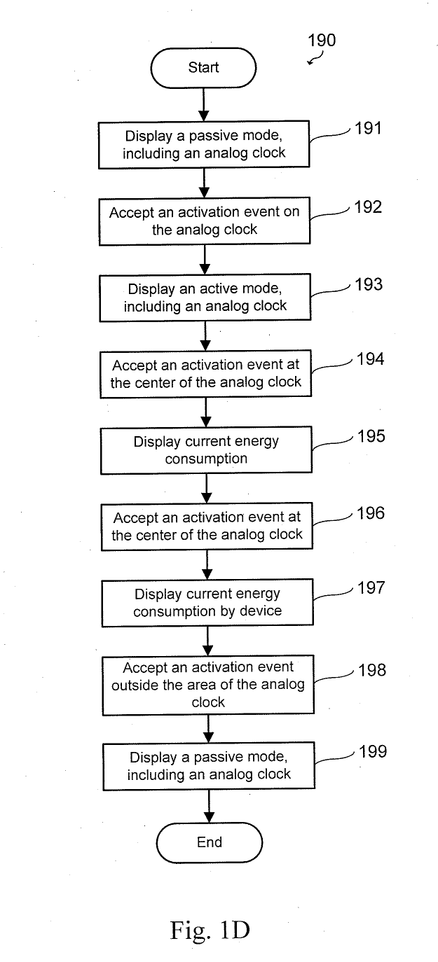

Various illustrative embodiments of the present invention are usable in single-metered and disaggregated environments including, without limitation, single-family homes; apartment dwellings; small, stand-alone businesses; and commercial building partitions. Such disaggregated environments may further include, without limitation, stand-alone buildings or dwellings fitted with more than one meter. For example, a homeowner could have an electric vehicle and the utility handles the additional load for charging the vehicle by installing new infrastructure and a second meter. As another example, a utility may install a second meter for electricity generation separate from a meter for electricity consumption for a household using a solar photovoltaic system. Also, various illustrative embodiments may communicate with information sources outside the environment in which it is used. For example, in one illustrative embodiment as shown in FIG. 1, the device 10 of the present invention can be used in a home 40 and can communicate through the internet 70 and the meter network 50 with the utility service provider 30 and other information sources. A data center 60 can be used to collect and manage energy usage data for homes 40 and other metered environments. Energy usage data can include, without limitation, energy cost data, energy consumption data, energy generation data, and other data related to energy use within a metered environment. In other embodiments, data can be managed elsewhere, including, without limitation, a utility service provider 60, a home 40 or other metered environment, or even within the device 10. Further, other energy and data network topologies can be used to communicate data and provide energy to a metered environment instead of that illustrated in FIG. 1. For example, the present invention can be used in many types of energy distribution environments, including regulated or deregulated markets, demand response environments, distributed generation environments, smart grids, and other types of energy distribution environments. As mentioned above, other data management techniques can be used and further combined with or separated from the energy distribution environment. For example, data management can be integrated with the energy distribution technique or isolated to the metered environment.

The embodiment shown in FIG. 1 illustrates that a metered environment 20, within which the device 10 operates can be sub-metered to manage individual appliances 11-14 or circuits independently or in conjunction with other appliances or circuits. The embodiment shown in FIG. 1 specifically shows that a specific electrical outlet 11, some generic appliance 12, a washing machine 13, or electrical vehicle 14 can be disaggregated and managed individually through device 10. Furthermore, electrical vehicle 14 illustrates that transient appliances (i.e., appliances not permanently affixed to the metered environment) can be managed through device 10.

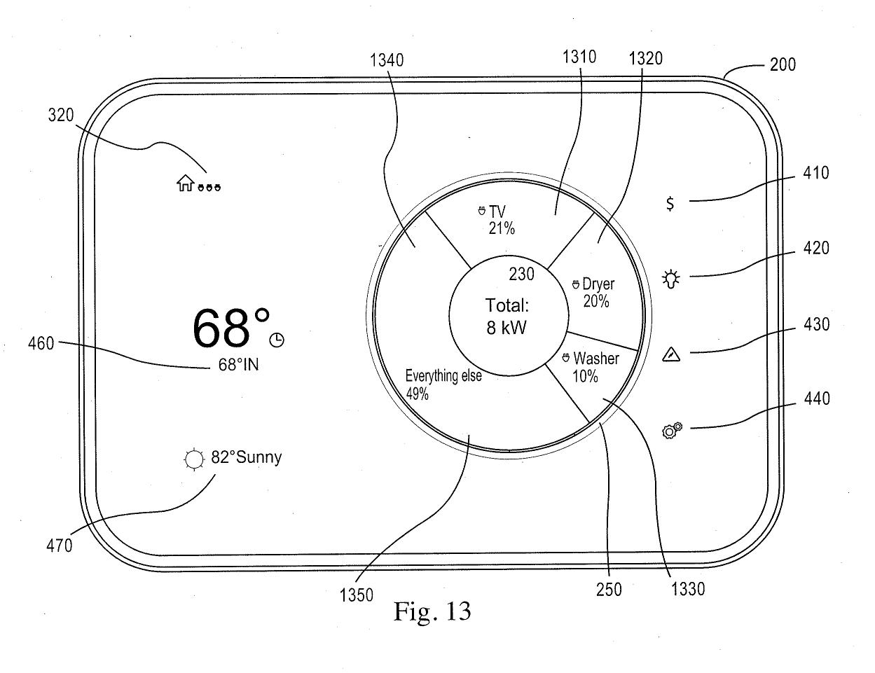

In illustrative embodiments as shown in FIGS. 13-15, the device can take advantage of sub-metering by displaying data specific to circuit elements, including individual appliances or fixtures on a circuit, groups of appliances or fixtures on a circuit, whole circuits, or a collection of circuits. A circuit element can be associated with a metering device that provides the sub-metering. Those of skill in the art understand that disaggregating specific devices or circuits can be accomplished by techniques other than sub-metering with a metering device, such as filtering or DSP algorithms. Irrespective of a particular disaggregation technique used, embodiments of the device can display data specific to disaggregated elements consuming or generating energy.

An illustrative embodiment of the present invention in the form of a functional block diagram of the device is shown in FIG. 1A. The device 100, as shown in FIG. 1A, can accommodate a processor 110 for processing instructions required for displaying appropriate information on the touch-screen display 120. Such instructions, as well as other data, can be stored in a memory 160. The processor 110 can also process data from a network via a network interface 130, including data from circuit elements using energy in the metered environment and data from the energy provider. The processor 110 can also process instructions required for receiving activation events from the touch-screen display 110 and retrieving and storing data from storage 150. In addition to a touch-screen display 120, the device 100 can include device controls 140 that can perform the same functions as touch-screen display 120 or can perform different functions, including turning on or off the device 100, setting the brightness of the touch-screen display 120, or other device control functions. Those of skill in the art understand that other embodiments may employ other components or employ components as shown in FIG. 1A external to the device 100. For example, other, non-touch-screen displays may be used. Furthermore, the components 110-160 of device 100 may be combined or further separated. Also, other embodiments may omit one or more of components 110-160 or include additional components.

Referring now to FIG. 1B, an illustrative embodiment of the present invention is shown which describes a method 170 for presenting energy consumption and cost data to the user. The method 170 may include, at 171, accepting energy consumption data from the network and, at 172, accepting energy cost data from the network. In other embodiments, the method 170 can retrieve data from the network. It should be understood that other techniques for the transference of data to the device 100 may be used. The method 170 may then, at 173, accept consumer-specific data from the network. The method 170 may then include, at 174, displaying some elements of an analog clock on the device. For example, in the embodiment shown in FIG. 1B, the method includes, at 174, the displaying of the minute and hour hand of the clock. In other embodiments, the device may further display a second hand. Other elements of a clock the device may display include, without limits, hour numbers around the perimeter of the clock, tick marks for the hours of the clock, and the image of a face of an analog clock. Additionally, the method 170 may include, at 175, displaying an orb coded to indicate current energy use, the orb centered on the analog clock face and, at 176, displaying arc segments coded to indicate energy cost and past energy consumption, the arc segments lying along the circumference the analog clock. It is to be understood that other embodiments may include other steps or modify the order of steps.

FIG. 1C is an illustrative embodiment of a method for displaying information about the user's energy consumption 180. The method 180 can include, at 181, accepting energy consumption data from the network. Again, the method 180 can include other techniques for the transference of data to the device. The method 180 can also include, at 182, detecting an activation event at the center of the clock. It should be understood that rather than an event detected at the center of the clock, an event can be detected elsewhere. Upon the detection, at 183, of such an event, the method can include, at 184, the display of information depicting the user's current energy usage. In the illustrative embodiment shown in FIG. 1C, the method can further include, at 185, the detection of another, similar activation event in the same location. Upon the detection, at 186, of that activation event, the method can include, at 187, the display of more detailed information about the user's energy consumption 187, including, but without limits, energy consumption by device.

FIG. 1D is another illustrative embodiment of a method 190 for displaying information about the user's energy consumption. Here, the method 190 includes, at 191, displaying a passive mode, as described below. The method 190 can then include, at 192, accepting an activation event on the analog clock and then, at 193, displaying an active mode that includes the display of a virtual analog clock, also described below. It is to be understood that, upon display of the active mode, certain aspects of the virtual analog clock can be made visible or more prominent. Additionally, display of the active mode can include the display of other display elements indicating energy usage, including cost and consumption. Energy consumption indications can also include energy generation indications.

Returning to FIG. 1D and the method 190, can further include, at 194, accepting another activation event at the center of the clock while the device is in an active mode. The method 190, can then include, at 195, displaying the current energy consumption. In other embodiments, at 195, the displaying the current energy consumption can further include reducing the visibility of the clock. In yet other embodiments, the clock may remain visible and other elements' visibility may be reduced or increased. Those of skill in the art understand that other embodiments may provide that the alteration of the appearance of an element may coincide with a similar or different alteration of appearance of other elements.

The illustrative embodiment as shown in FIG. 1D also depicts the successive nature of the device's information flow. For example, the method 190 can include at 196, accepting another activation event at the center of the clock 196 and, at 197 displaying further levels of detailed information about the energy consumption, including, without limitation, energy consumption by device. Again, other embodiments may accept activation elements elsewhere on the device to display further levels of detailed information. The method 190 may then allow for, at 198, the acceptance of another activation event and, at 199, a return to a passive mode. In other embodiments, the method can also allow for the acceptance of an activation event to return to a previously displayed level of information. Those of skill in the art understand that other embodiments can provide that even more detailed, less detailed, and other information may be displayed in response to another activation event.

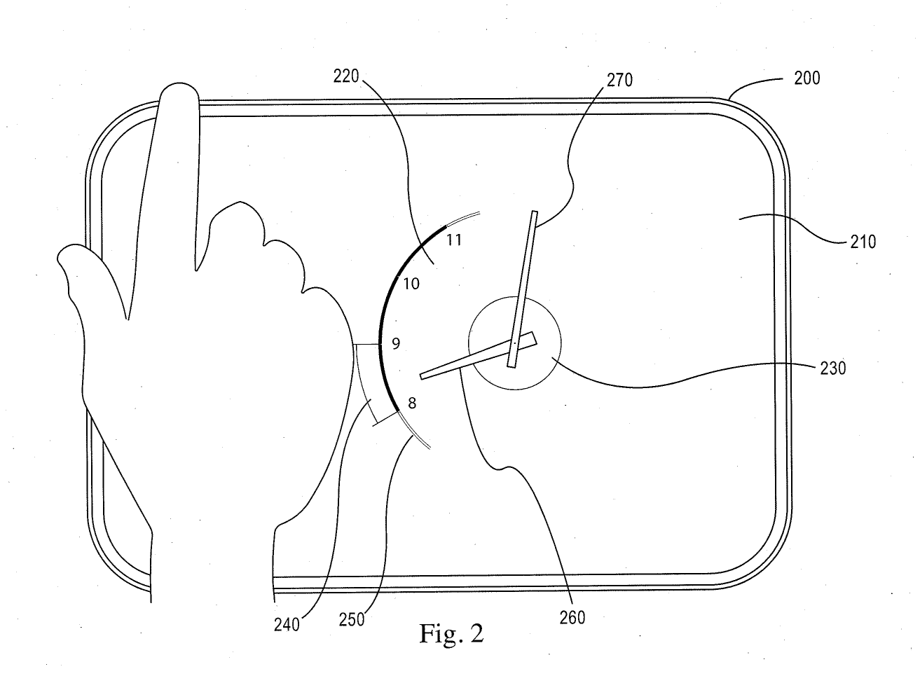

In reference to FIGS. 2-31, certain elements use shading, line weighting, broken lines, or some combination of the foregoing to illustrate how visual aspects of display elements can be used to communicate energy usage information to a user. For example, heavier line weights in the figures can indicate heavier outlining or stark outlining of a display element versus faded outlining of a display element. In FIGS. 2-31, a shaded display element is intended to convey a more brightly lit colored display element. In some embodiments, that color is some shade of red. It should be understood that a shaded display element can indicate a more brightly lit display element, a different color display element other than red, or some other visual aspect of a display element. In FIGS. 2-31, a display element with a broken line is intended to convey a colored display element. In some embodiments, that color is some shade of red. Again, however, it should be understood that a display element with a broken line outline can indicate a different color display element other than red, a display element with a different brightness, or some other visual aspect. In some embodiments, display elements shown as non-shaded regions or as solid lines are colored display elements of a color different from that of the shaded regions and broken lines discussed above. In some embodiments, that different color is some shade of green. In other embodiments, a color other than green can be used. It should be understood that the shading and line types used in FIGS. 2-31 merely indicate various visual aspects of display elements and are not intended to be limiting. Those of skill in the art understand the various visual aspects of a display element, including color, size, brightness, shape, and outlining, that the shading and line types used in FIGS. 2-31 can indicate.

Referring now to FIG. 2, in one illustrative embodiment, the interface 210 of device 200 features a graphic (virtual) analog clock 220 that has a color-coded orb 230 at its center and one or more color-coded arc segments 240 along its circumference. In one embodiment, the orb 230 and arc segments 240 may have diffuse or blurred edges. In other embodiments the edges may be stark. It is to be understood that the virtual analog clock may take shapes other than circular. For example, a virtual analog clock may take an ovular or multi-lateral shape. The orb described herein can also take other ovular or multi-lateral shapes, either similar to or different from the shape of the clock. The arc segments described herein can take different shapes or placement to signify periods of time around the clock. For example, in an exemplary embodiment, the virtual analog clock and orb may take a square shape and arc segments may take multi-lateral shapes and occupy area around the perimeter of the clock. Those of skill in the art can readily understand that other combinations of shapes can be used to form the appearance of the clock, orb, and arc segments.

In one embodiment, the device 200 can have a passive mode in that some elements of the graphical user interface 210 are visible, have reduced visibility, or increased visibility while others are invisible. In other embodiments, other visual aspects of display elements can be altered for a passive state. For example, in one illustrative embodiment, only elements of the analog clock 220 are visible so that the device 200 is an aesthetically pleasing wall clock or table clock, as shown in FIG. 32.

In some embodiments, the orb 230 and arc segments 240 can operate as activation elements for the user to obtain more detailed information about their energy usage. For example, selecting the orb 230 or an arc segment 240 when the device 200 is in passive mode can cause the device 200 to enter active mode. Further, whether in passive or active mode, the user may be able navigate to the same information by selecting an activation element. A passive mode, as briefly mentioned above, can include a state in which only part of the virtual analog clock 220 is displayed, the entire virtual analog clock 220 is displayed but other display element of the device 200 are dimmed, or some visual state in which fewer than all activation elements or display elements are brightly visible. An active mode can include a state in which all the display elements or activation elements are visible or more brightly lit, the entire virtual analog clock 220 is visible or brightly lit, or some combination of clock 220 aspects and display elements or activation elements are visible or brightly lit more than they would be in a passive mode. Visual aspects other than visibility or brightness can indicate or accompany a passive or active mode, including color, size, shape, presence of icons, outlines or edging, or some other visual aspect.

In another embodiment, activation elements may include other displayed icons or buttons on the device. For example, FIG. 4 illustrates an embodiment that includes activation elements 320, 410-440, 460, 470 outside the perimeter of the clock 220. It is understood by those skilled in the art that activating the display of information or navigating through the device's screens can be achieved in different ways.

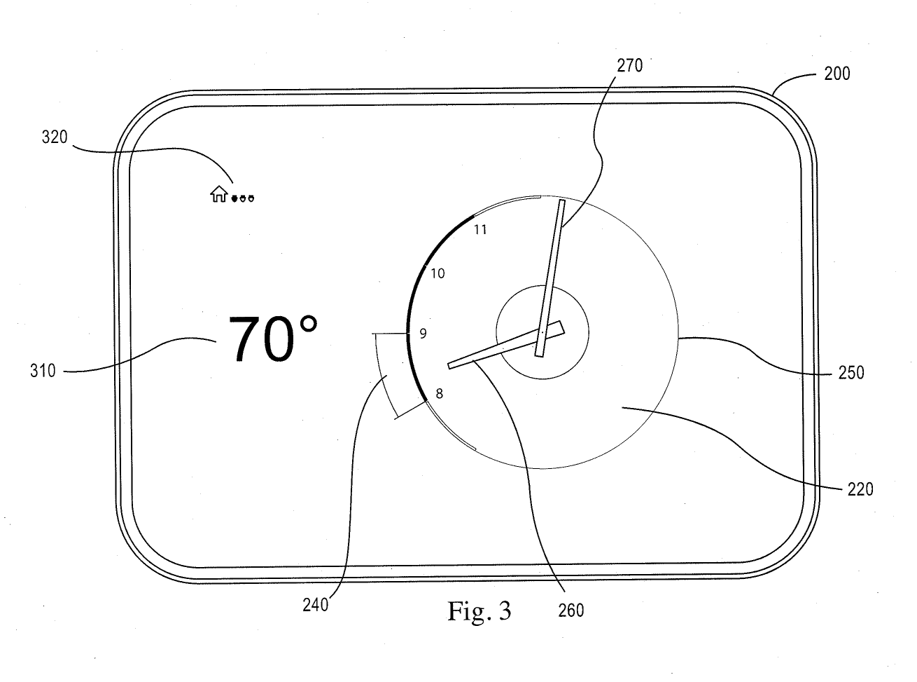

Referring now to FIG. 3, in another embodiment, a passive mode can display both the clock 220 and the current ambient temperature 310 around the device 200, similar to the function of a thermostat. A temperature displayed by the device may be a remote ambient temperature. In yet another embodiment, the orb 230 and arc segments 240 may be partially visible as in FIGS. 2 and 3. Other possible elements include, but are not limited to, outside temperature and device status. For example, FIG. 3 includes a home and away icon 320 indicating a HOME mode at the top left corner of the device. Other similar indicators may indicate an AWAY mode. The home and away icon 320 can be used as an activation element to set thermostat and other settings according to whether the consumer is or will be in the metered environment or away from the metered environment. Further, FIG. 3 also shows a volt status in the three small icons to the right of the HOME mode indicator, the volt status indicating current energy consumption. Those of skill in the art understand that other combinations of elements can be displayed in a passive mode.

Returning to FIG. 2, in a passive mode the device 200 may display only portions of the clock 220 based on the current time or on some other metric. For example, in one illustrative embodiment, the device 200 can display clock hands 260, 270 and arc segments 240 of the clock 220 for the current and next two hours. In another embodiment, other segments or the whole clock 220 may be displayed in a passive mode.

The device 200 may also offer an active mode which may be triggered by the user touching an area of or moving within close proximity of the device 200. Those of skill in the art understand that interacting with the device 200 may be accomplished through the use of touch-screen technology, by tactile buttons or switches on the device 200, or remote user activity. It should be understood that interaction with the device may be accomplished through different user actions.

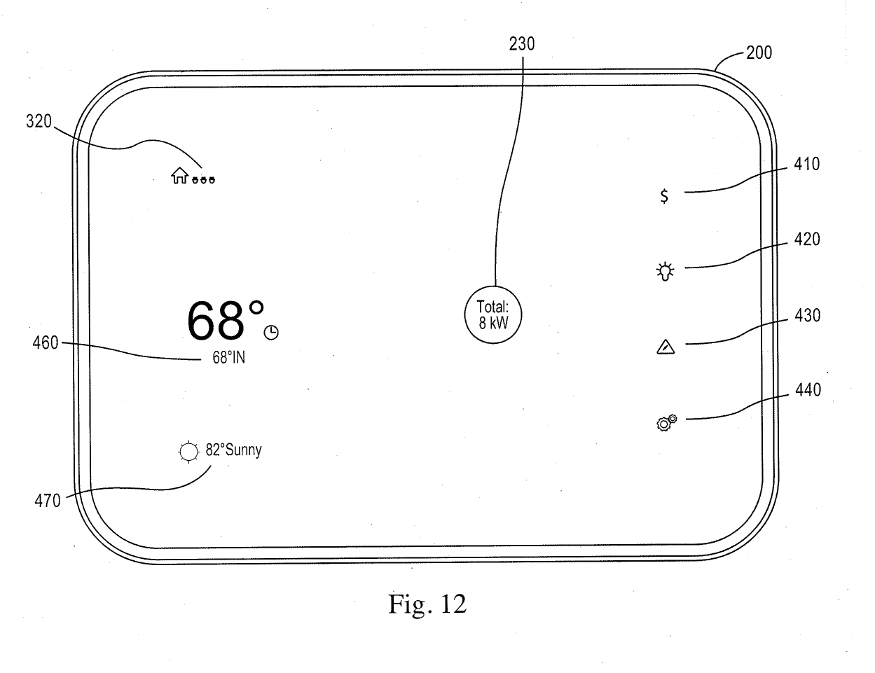

The orb 230 and arc segment 240 color-coding and sizes may offer insight into the user's energy consumption and the utility service provider's peak and off-peak energy price periods. For example, in one embodiment, the orb 230 may have color-coding to indicate favorable and unfavorable energy consumption. For example, in one illustrative embodiment, a green orb 230 may indicate relatively low or favorable energy consumption, while red may indicate relatively high or unfavorable energy consumption. Furthermore, the orb's 230 size may also indicate favorable or unfavorable energy usage. For example, the orb 230, as shown in FIG. 4, or a larger orb, may indicate unfavorable energy consumption in contrast to the smaller orb 230 in FIG. 12. It is understood by those skilled in the art that energy consumption could be indicated in the orb 230 by changing the appearance of the orb 230 by its color, brightness, shape, size, outlining or edging, inclusion of an icon or text, or some other visual aspect.

Similarly, the appearance of an arc segment 240 can be used to indicate the cost or some other attribute, for example CO₂ or renewable generation of energy, during the time slice represented by the position of the arc segment 240 along the circumference of the clock 220. The arc segment 240 appearance can change according to the cost or some other attribute, for example CO₂ or renewable generation of energy during the time, according to whether the time slice occurs within the utility service provider's peak or off-peak energy usage time, or according to some combination of energy usage and cost or generation mix (nuclear, coal, natural gas, hydro or other source). For example, in one embodiment, an arc segment 240 for a time period may appear red when that time period falls within a peak or non-renewable or CO₂ generating usage period. In contrast, the arc segment 240 may appear green for off-peak or “clean” or renewable usage periods. In another example, an arc segment 240 may appear red but brighter relative to other arc segments for periods that fall in the utility's peak energy usage period and the consumer's high energy usage period. In yet another example, an arc segment's 240 width may be accentuated or enlarged to indicate whether the device 200 is in active or passive mode. If the consumer has local generating capability, such as a photovoltaic array or wind power, the arc segment 240, for example, could be a calculation of local, renewable generating capacity and energy available from the utility grid. Those of skill in the art understand the various energy consumption and electricity generation variables that the visual aspects of displayed elements may depict. Like the orb 230, characteristics of an arc segment's appearance can provide an indication of energy usage, those characteristics including its color, brightness, shape, size, outlining or edging, inclusion of an icon or text, or some other visual aspect.

Returning to FIG. 3, such adaptation of an arc segment 240 to underlying energy consumption and cost information is shown in a passive mode by a brightly-colored arc segment 240 relative to the other segments along the perimeter 250. In some embodiments the arc segment 240 could have a solid outer edge while in other embodiments the outer edge could fade into the rest of the display. Other visual aspects of the arc segment 240 can be modified to indicate energy usage information, including energy cost information, energy consumption information, or some other information related to energy usage. It is understood by those in the art that the shape, color, size, brightness, outlining or edging, inclusion of an icon or text, or other visual aspects, and combinations of visual aspects of the orb 230 and arc segments 240 can indicate energy usage, energy cost, generation characteristics, and other useful information in the passive and active modes.

In one illustrative embodiment, an active mode may use color coding similar to that of a passive mode. Red arc segments 240 can indicate peak periods, while green arc segments 240 can indicate off-peak periods. A red orb 230 can indicate high energy consumption by the user, while a green orb 230 can indicate low energy consumption. Of course, other color-coding or coding by some other visual aspect can be used to graphically portray information. In another example, arc segments 240 along the edge of the clock in an active mode can become more prominent and can display other indicators.

For example, FIG. 4 shows an embodiment with arc segments around the entire perimeter 250 of the clock 220, all of which have an increased width. FIG. 4 illustrates an active mode in which the entirety of the clock 220 is visible along with other activation elements, including icons 410-440, thermostat control 460, home and away icon 320, and external weather 470. Arc segment 450 illustrates the use of icon-coding in which an arc segment is labeled with a “!” icon to indicate some further information pertinent to the consumer beyond the color-, shape-, and outline-coding shown in other arc segments. This and other iconic visual cues can further indicate energy cost or consumption information pertinent to the time period indicated by an arc segment. Other types of coding are shown by the brightly-lit arc segment 456 versus the more dimly-lit arc segment 452 and the brightly-lit arc segment 458 versus the more dimly-lit arc segment 454.

Icons 410-440 include spending activation element icon 410, an energy usage activation element icon 420, an energy provider information activation element icon 430, and a settings activation element icon 440.

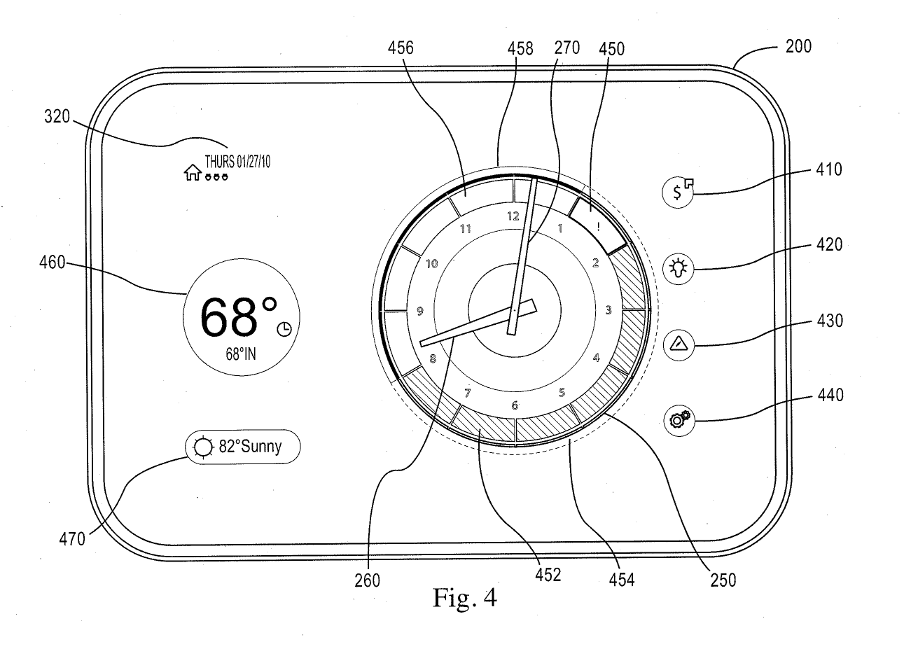

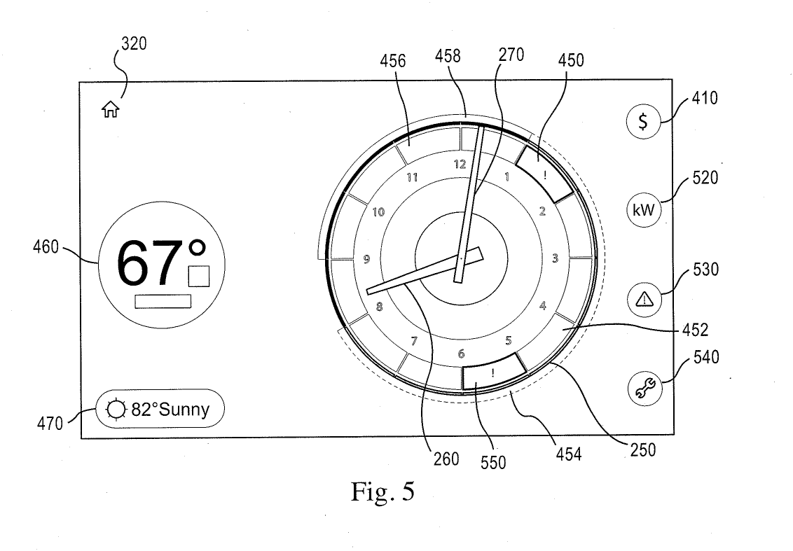

FIG. 5 illustrates an embodiment that shows that other icons can be used for the activation elements, including energy usage activation element icon 520, energy provider information activation element icon 530, and settings activation element icon 540. Those of skill in the art understand that other icons, other activation elements, or controls can be used to achieve the same result. The embodiment shown in FIG. 5 also illustrates that more than one arc segment can include additional coding as shown by arc segment 550.

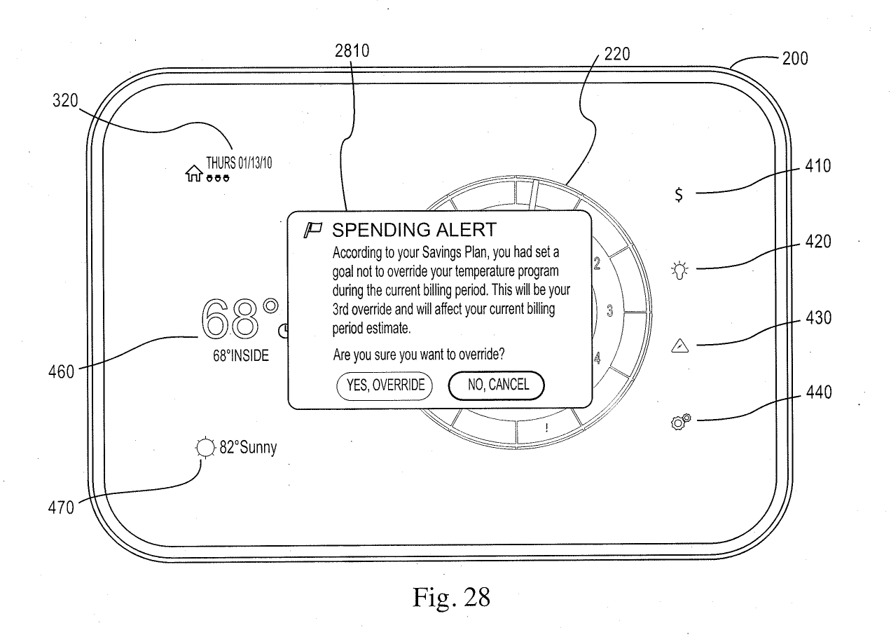

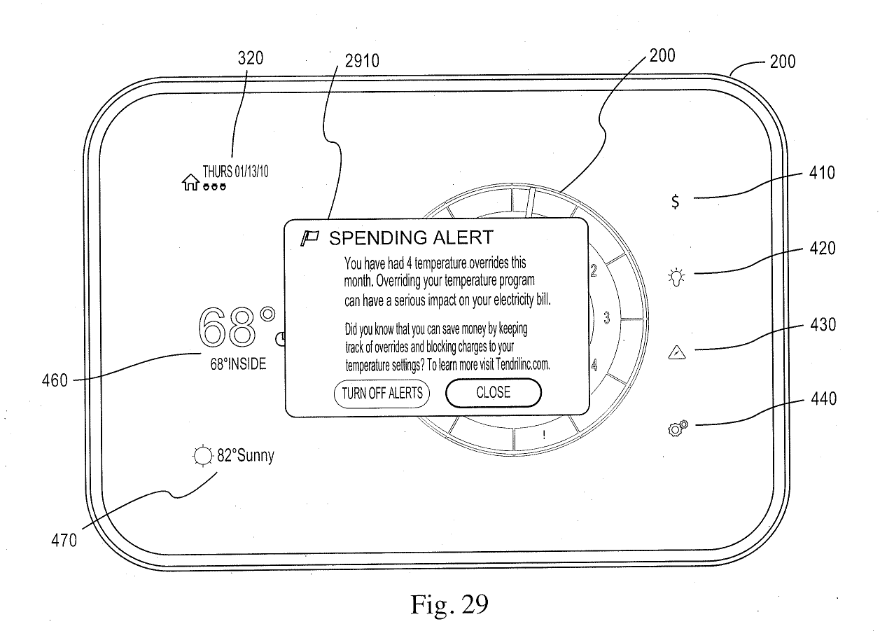

Furthermore, as illustrated in the embodiments of FIGS. 28 and 29, the activation elements, based on their coding, can lead to alerts or other information for the metered environment. Specifically, FIGS. 28 and 29 show spending alert and warning 2810 that can be displayed upon selection of arc segment 550. The icon coding of arc segment 550 can indicate to a user that a spending alert 2810 applies to the time period indicated by the arc segment. In other embodiments, spending alert and warning 2810 may be displayed upon some other event. For example, upon some energy cost or consumption reaching some predetermined threshold, spending alert and warning 2810 may be displayed. Upon overriding spending alert 2810, spending alert 2910, as shown in FIG. 29, can be displayed alerting the user of the effect of cumulative overrides. Other alerts or warnings can similarly be displayed upon user activation or detection of some event or predetermined threshold or condition. It should be understood that predetermined thresholds may include, without limitation, a spending threshold or energy consumption threshold for one or more circuit elements. Additionally, such predetermined thresholds can be set according to user preferences or energy provider recommendations or requirements.

Returning now to FIG. 4, the embodiment shown also illustrates the how device 200 can be further used for common thermostat functions. Thermostat control 460 can be an activation element within the display interface 210 where, upon activation by a user, the user can control thermostat functions within the metered environment. The device 200 can also include information external to the metered environment, including an outside weather indicator 470.

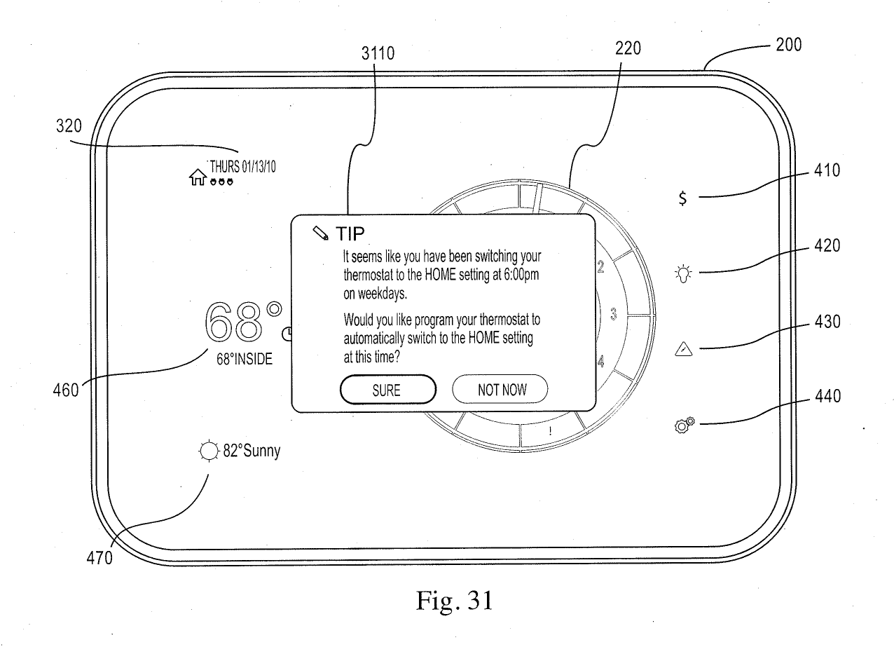

FIG. 31 shows an embodiment of the useful information, beyond that of a thermostat, that device 200 can provide. For example, device 200 can track energy consumption information including thermostat changes and make suggestions accordingly. Specifically, if the user changes settings via the home and away icon 320 or the thermostat control 460, the device can provide an energy consumption tip 3110. Those of skill in the art can understand the types of information that can be tracked by device 200 and the type of advice that can be presented to a user based on that information.

The embodiment shown in FIG. 6 illustrates an arc segment 610 that can span a period of time other than an hour. Arc segment 610 further illustrates yet another icon that can be used to communicate information to the consumer. In this case, arc segment 610 includes an icon similar to that of energy provider activation element icon 430. In this case, arc segment 610 can be an activation element and the consumer can select arc segment 610 to view further information about the 6 p.m. to 8 p.m. time period. For example, selecting arc segment 610 can lead to the display of projected energy cost information, projected energy consumption information, or energy provider messages relating to the 6 p.m. to 8.p.m. time period or other information related to energy consumption for the 6 p.m. to 8 p.m. time period.

In one illustrative embodiment, each successive activation by the user can cause the device 200 to display more detailed information which overlays the circular area originally occupied by the graphical analog clock 220. Also, each successive action may cause the device 200 to display less detailed information or other information entirely. The elements displaying information can be centered on the clock 220, and each successively-displayed piece of information can overlay the previously displayed information or the activation element from which the detailed information was triggered. For example, in one embodiment, FIGS. 12 and 13 indicate a successive nature of information and location of displayed information. FIG. 12 displays current energy consumption in an active mode. Selecting the energy consumption orb 230 in the active state can then cause the device 200 to display the pie-chart-like graphic 1350, as in FIG. 13, displaying more detailed information about energy consumption per circuit element. The embodiment of FIG. 13 includes orb segments for disaggregated appliances, including an orb segment for a TV 1310, an orb segment for a dryer 1320, an orb segment for a washer 1330, and an orb segment for all other appliances 1340 in the metered environment. It should be understood that, in other embodiments, other and more disaggregated circuit elements can be represented than those shown in FIG. 13.

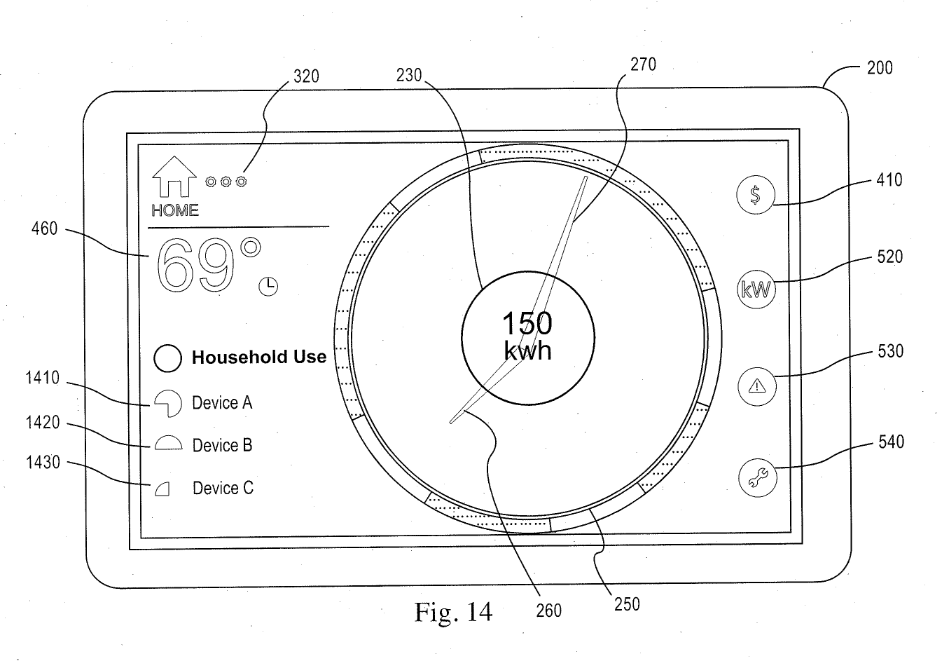

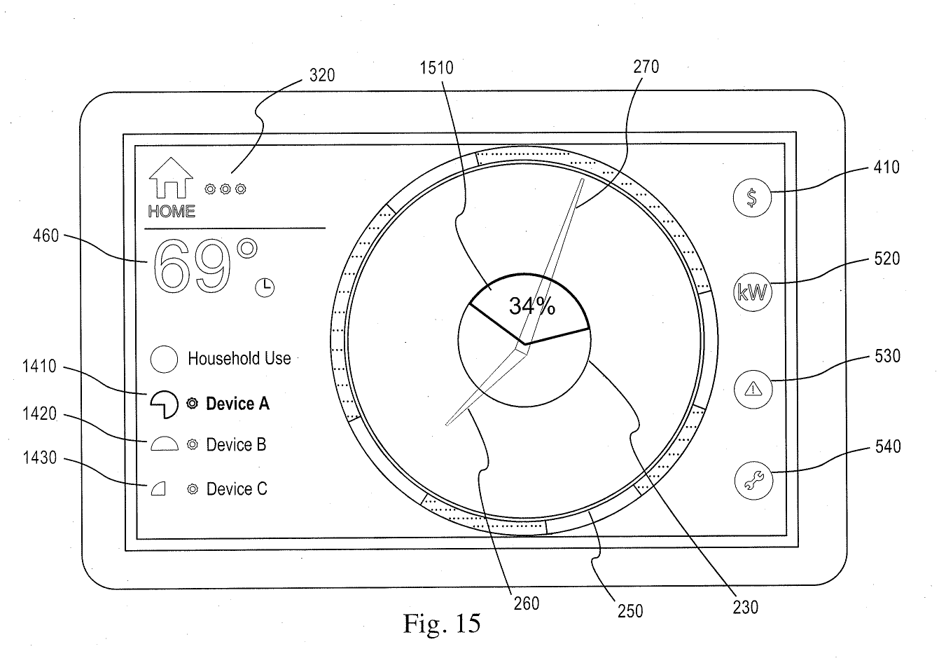

Refer next to FIGS. 14 and 15, which show yet another embodiment for displaying energy consumption data for the metered environment and disaggregated circuit elements via the orb 230. Specifically, FIG. 14 shows that activation elements 1410, 1420, 1430 can be used for disaggregated circuit elements outside the area of the clock 220. Upon selecting activation element 1410, orb segment 1510 can be displayed as part of the orb 230 showing the energy consumption of disaggregated “Device A,” as shown in FIG. 15

Further successive activation by the user can cause the device 200 to display circuit-element-specific energy consumption and cost information and status and allow the user to set rules of energy consumption for specific circuit elements (e.g., devices, appliances, circuits, or combinations of circuits). It is understood by those skilled in the art that other types of information may be displayed and that further successive graphics and control mechanisms may be implemented.

In one illustrative embodiment, the device 200, in an active mode, can display information and virtual buttons or other activation elements pertinent to the event that triggered active mode. Furthermore, a user or a notification event may trigger active mode. For example, a specific trigger may be programmed by the user so that if a circuit element meets certain conditions including, without limitation, exceeding electricity usage and exceeding a cost threshold, a visual indication occurs.

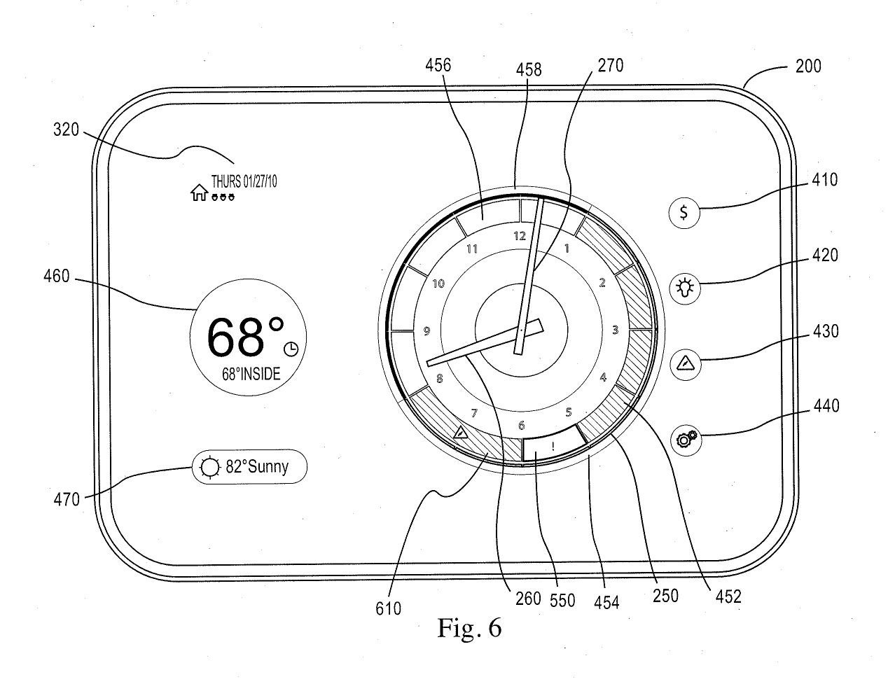

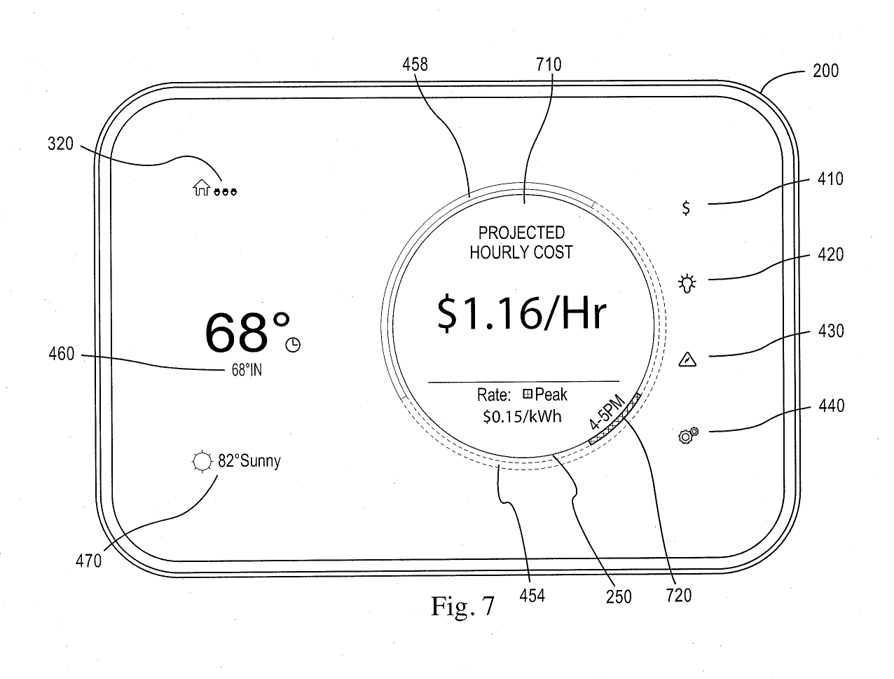

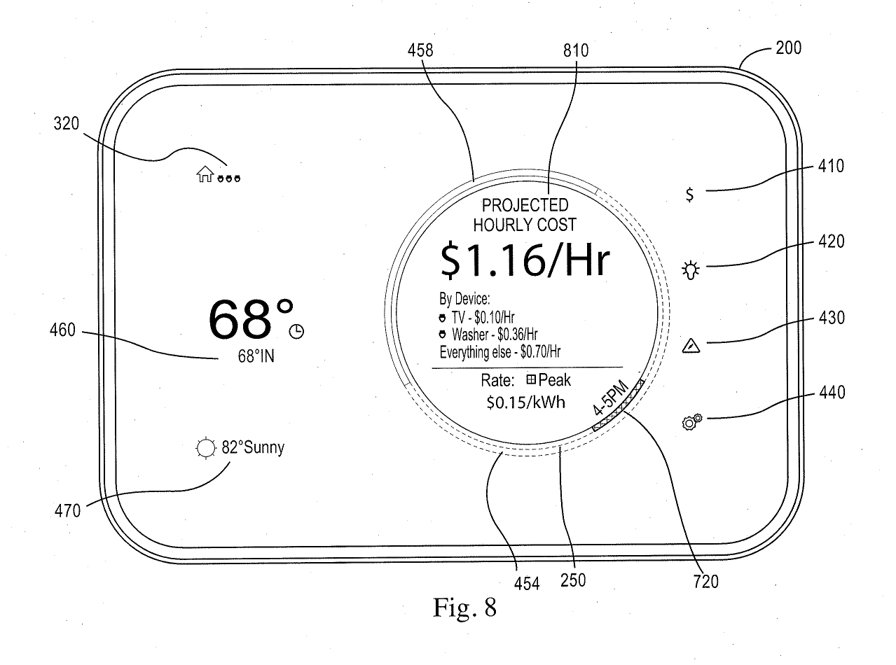

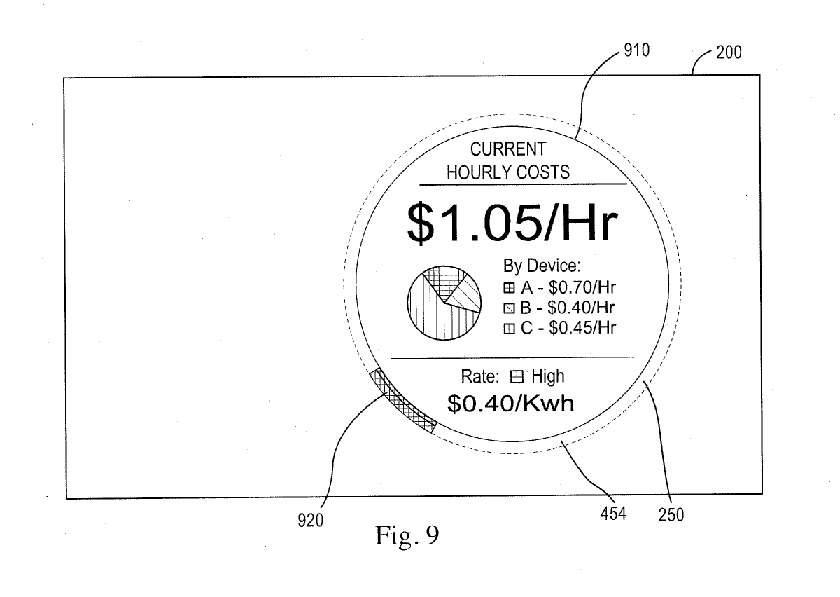

As noted above, arc segments 240 may portray information through their visual aspects, including other icons or symbols associated with an arc segment. In one illustrative embodiment, many navigation paths through information exist via the activation of graphical elements in the device 200. Navigation paths may depend not only on the activation element triggered but the nature of the information associated with the activation element or depicted on the device. For example, selecting an arc segment 240 without an indicator may display projected hourly cost and other data 710, as shown in FIG. 7 for a particular time period as indicated by arc segment 720. In particular, the data may include the cost per hour of the user's past total and by-device or by-circuit energy consumption during the period and the rate (cost) per kilowatt-hour, as shown in FIGS. 8 and 9. Specifically, the embodiment shown in FIG. 8 illustrates the display of projected hourly cost 810 for the metered environment and disaggregated circuit element within the metered environment for the time period indicated by arc segment 720. The embodiment shown in FIG. 9 illustrates the display of projected hourly cost 910 again for the metered environment and disaggregated circuit element with the metered environment for the time period indicated by arc segment 920. However, FIG. 9 illustrates that the graphical representation of information can take different forms. FIG. 9 further shows that some embodiments may dim display elements other than those elements the user interacts with.

In yet another embodiment, a user may select an arc segment 240 to cause the device 200 to display high-level information, such as the projected hourly cost 710, as shown in FIG. 7, and then select that information display element to cause the device 200 to display lower-level information, such as the disaggregated projected hourly cost 810 as shown in FIG. 8. In one illustrative embodiment, reverse navigation may also be possible. For example, to cause the device 200 to return to a mode showing just the clock 220, the device 200 may allow for the user to select an area outside the information display element. Those of skill in the art understand that other information associated with energy cost and usage, including, without limitation, cost and usage for specific circuit elements or specific user patterns, may be depicted by activating an element and that causing other information to be displayed can take other navigation paths.

Furthermore, while in active mode, the device 200 may also highlight and flag arc segments 240 in particular circumstances. For example, by incorporating past energy consumption patterns of the user, the device 200 may flag a peak period as also being a high consumption period historically for the user. In that case, the arc segment 240 can brighten further and display an exclamation point (“!”), as shown by the one o'clock hour arc segment 450 in FIG. 4. This additional notification can identify for the user an opportunity to reduce their energy bill by “time-shifting” their energy consumption to an off-peak period. For example, in reference to FIG. 4, the user could operate their air conditioner in the twelve o'clock hour to reach an indoor temperature lower than the thermostat setting. Then, during the peak period, the air conditioner would either not operate or operate less frequently. Because the indoor temperature is lower than the thermostat setting, there would be less of a need to operate the air conditioner during the peak period. Thus, the operation of the air conditioner would be “time-shifted” to an earlier, off-peak period.

In another example, the device 200 could compare real-time or near-real-time usage to historical averages. Specifically, if real-time or near-real-time behavior deviates from historical patterns a visual indicator can alert the user so that they can take appropriate action if necessary. Those of skill in the art understand that other types of opportunities for energy conservation can be offered to the user through display elements on the device and that such opportunities or presented information can be based on other types of data.

In one illustrative embodiment, selecting an arc segment with an exclamation point indicator 450, as shown in FIG. 4, may cause the device 200 to display heightened alert 1010 with the amount the user could save by taking advantage of “time-shifting,” as shown in FIG. 10. Such a heightened alert 1010 could also include information about participating in a “time-shifting” event offered by the utility service provider. Those skilled in the art understand the different types of savings events or opportunities that may be presented to a user and that may be based on energy consumption or cost. FIGS. 4-6 depict examples of specific indicators. It should be understood that these indicators are merely examples of indicators that may be presented to the user and that the present invention is not limited to only those indicators.

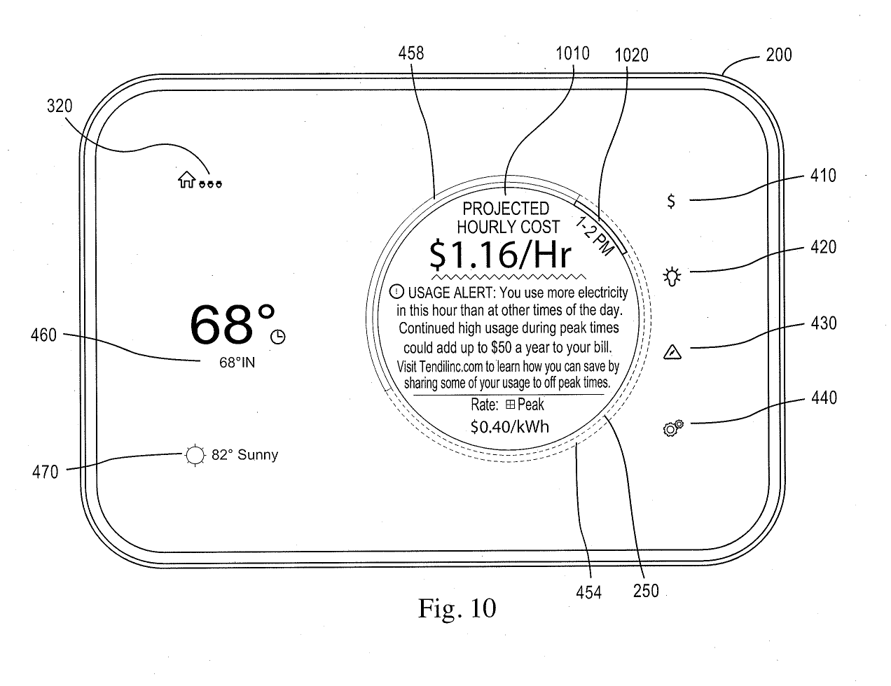

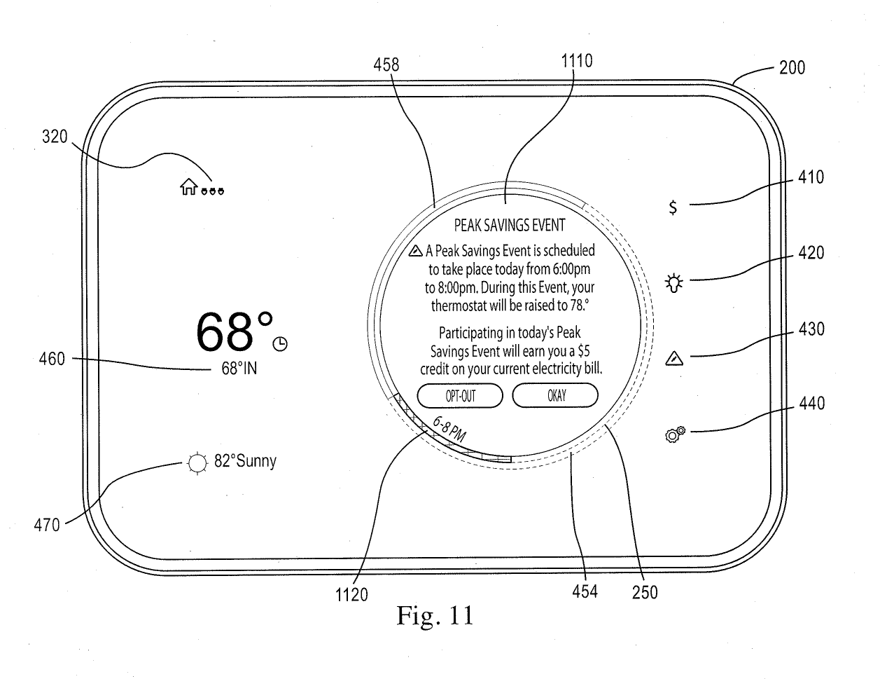

For example, activating an arc segment 240 with another indicator may display a user's selected peak savings event. An illustrative embodiment as in FIG. 6 shows an arc segment with a triangle encompassing a lightning bolt 610. Activating this arc segment 610 may cause the device 200 to display information about a “time-shifting” energy consumption event 1110, as shown in FIG. 11. Again, this information display element 1110 can be displayed over and centered on the clock 220 along with the arc segment 1120 indicating the time period. Also, in one illustrative embodiment, it may be possible to offer other user interaction with information display elements. For example, as in FIG. 11, the user is offered an opportunity to participate in the “time-shifting” or to opt out. Those skilled in the art understand that other indicators may lead to other types of information related to energy consumption and cost, and those types of information could be displayed in a manner similar to that in FIG. 11.

A peak savings event may include an event sponsored by a utility service provider, which, for a deregulated market, may include, without limitation, a retailer, distribution service provider, or generator. Other peak savings events may include a consumer-specific event, cycling a circuit element, changing the setting of a circuit element, or shifting the “on” state of a circuit element to a delayed time to consume less energy. A peak savings event typically is part of an energy provider's program for encouraging energy efficiency and reduced consumption during peak demand times and may be accompanied by consumer rebates.

Presenting information to the consumer about energy savings or conservation may be implemented through other display and activation elements or controls as well. Furthermore, other energy savings programs offered by utility service providers and consumer-specific opportunities to conserve can be included. For example, an arc segment 240 or orb 230 may be coded through some visual aspect or be associated with some other indicator that the consumer's energy consumption is higher during the period represented by the arc segment 240 than other periods irrespective of cost. Those skilled in the art understand that consumer-directed information about conservation and savings may be depicted graphically.

Activating an element associated with another visual indicator may display different information than activating a similar element that is not associated with an indicator. For example, selecting an arc segment 240 with an indicator can display different data than selecting an arc segment 240 without an indicator. More specifically, selecting a peak period and high consumption arc segment 240 as described above can display a heightened alert 1010, as in FIG. 10, with the amount the user could save by taking advantage of “time-shifting.” Again, arc segment 1020 is visible, indicating the pertinent time period. Selecting an arc segment 240 without an indicator might show only projected energy consumption cost, as in FIG. 7, or some other information related to energy use. Those of skill in the art understand that information caused to be displayed on the device 200 by selecting an element can be made to depend on the settings of the visual aspects of the element and the underlying information supporting the visual aspects.

In one illustrative embodiment, other activation elements may lead to even more information. For example, as shown in FIGS. 6 and 14, the interface 210 may accommodate activation elements apart from or not centered on the clock 220. Activating other elements may lead to more detailed information about energy consumption, or information or alerts about current usage or trends compared to historical patterns and physical influences such as weather.

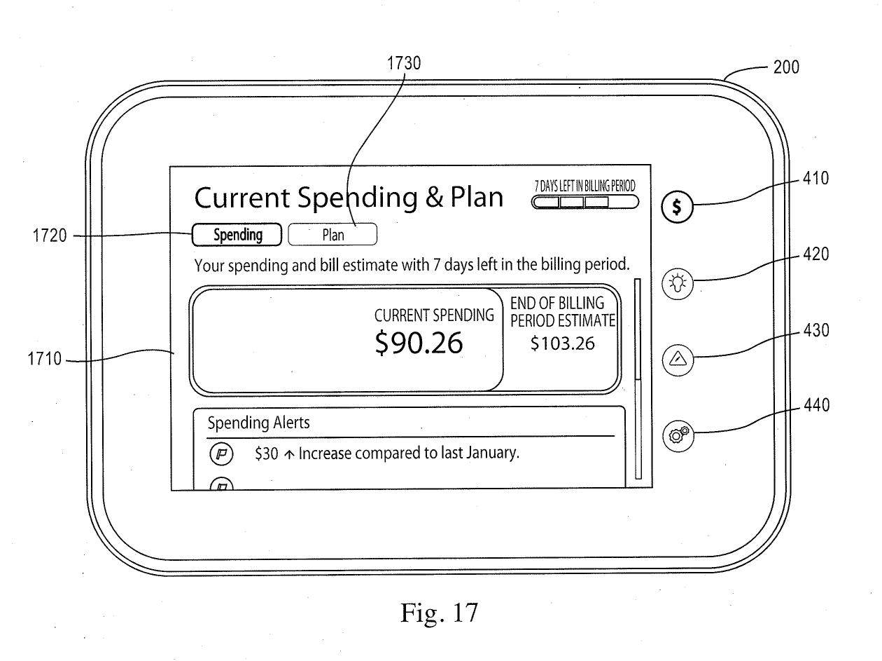

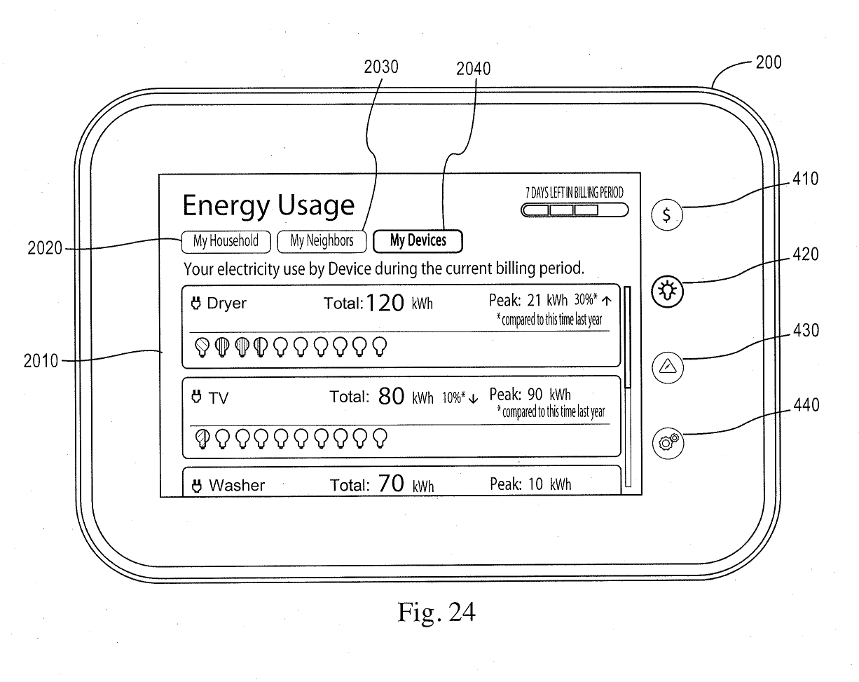

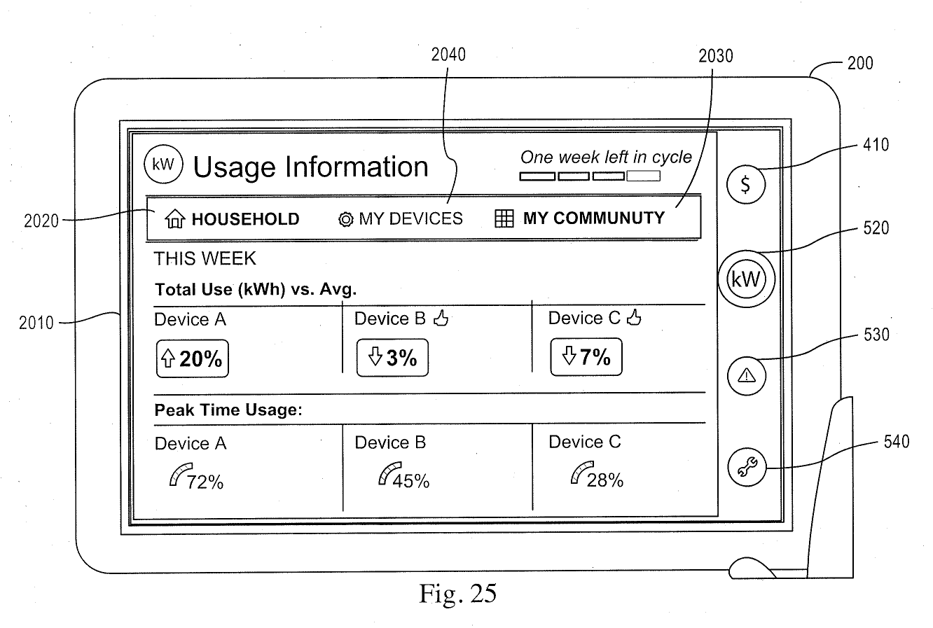

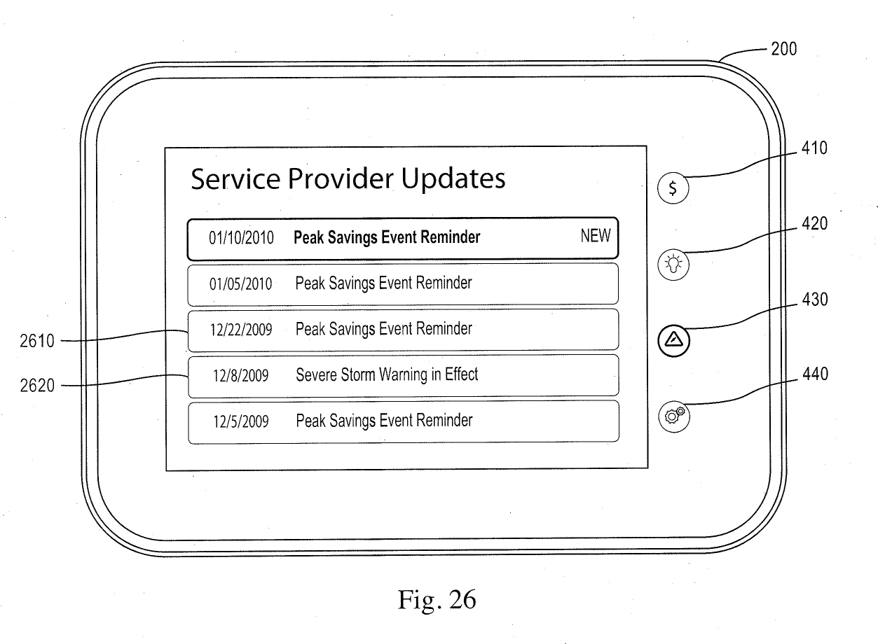

For example, an activation element may lead the user to detailed information about their energy spending for a period of time, as in FIGS. 17-19, including during the user's current utility service provider billing cycle or energy spending by circuit element, as shown in FIGS. 24 and 25. In another example, activating an element may display peak savings events scheduled for the user or peak savings events available to the user 2610, as shown in FIG. 26. In yet another example, activating an element may display weather alerts 2620 affecting the user, as shown in FIG. 26. Those of skill in the art understand that other information from a utility service provider or pertinent to the user and their energy consumption can be depicted.

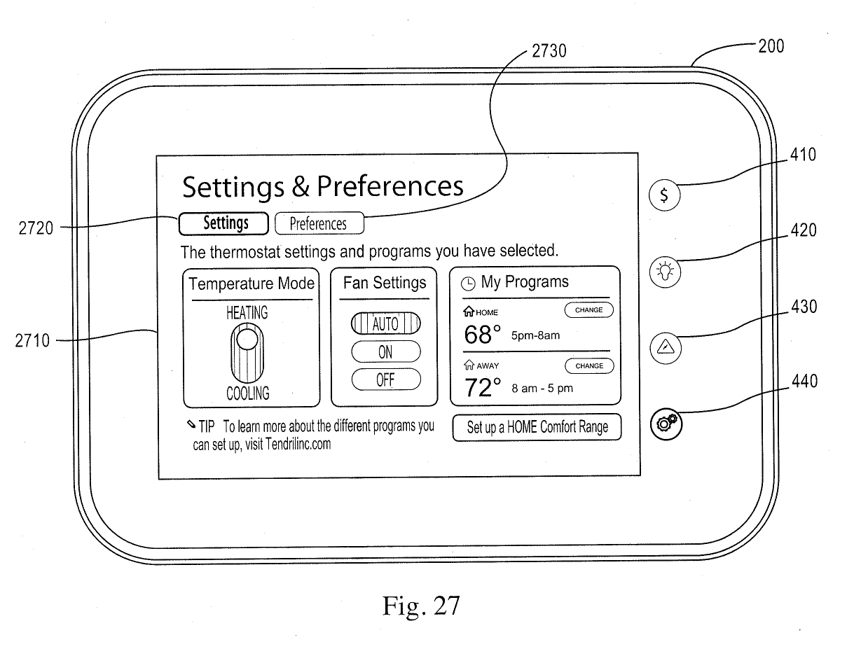

An illustrative embodiment of the invention can combine traditional energy use meters and devices like thermostats and programmable thermostats. For example, in FIG. 3 is shown an embodiment displaying the temperature 310; in FIG. 4 is shown an embodiment with the indoor temperature 460 and the current outdoor temperature 470; and in FIG. 27 is shown an embodiment displaying thermostat settings 2710. Furthermore, embodiments of the invention can be combined with other information displays such as utility service provider billing and energy usage information, as shown in FIGS. 17-25 and 28-31.

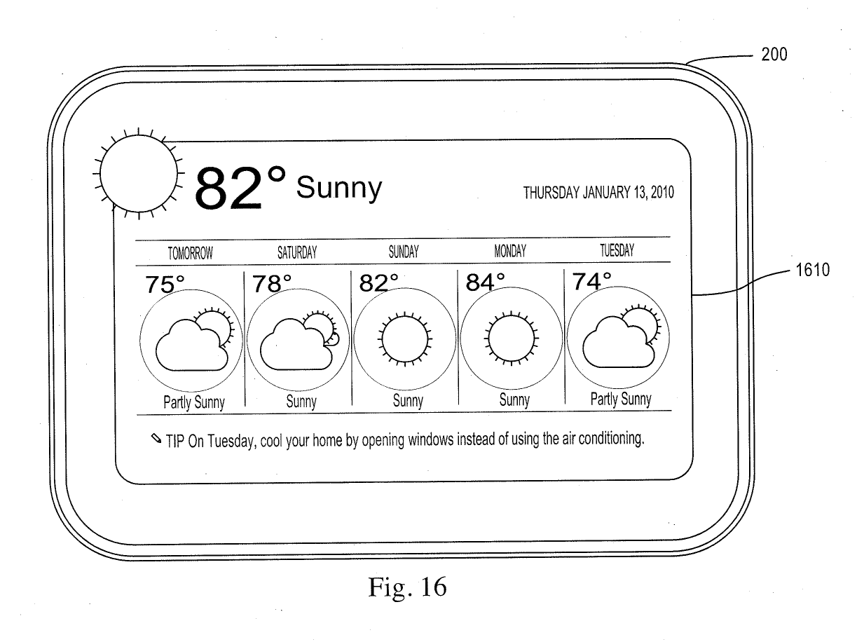

Referring now to FIG. 16, an embodiment is shown in which the device 200 can be used to display weather information 1610. Such information can be presented with other energy usage information and tips as shown in FIG. 16. Weather information 1610 can be displayed upon selection of an activation element of the display 210, such as outside temperature 470, or some other control of the device 200.

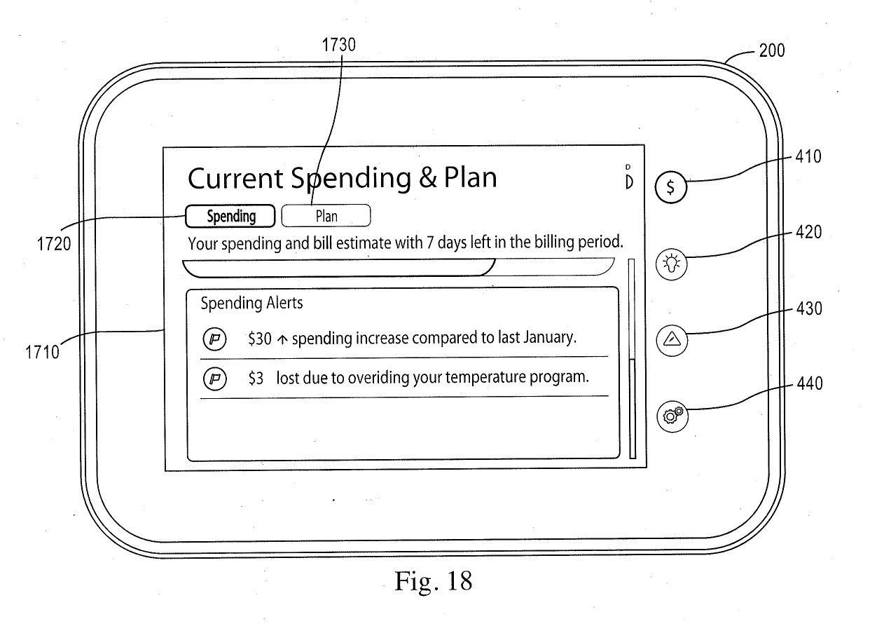

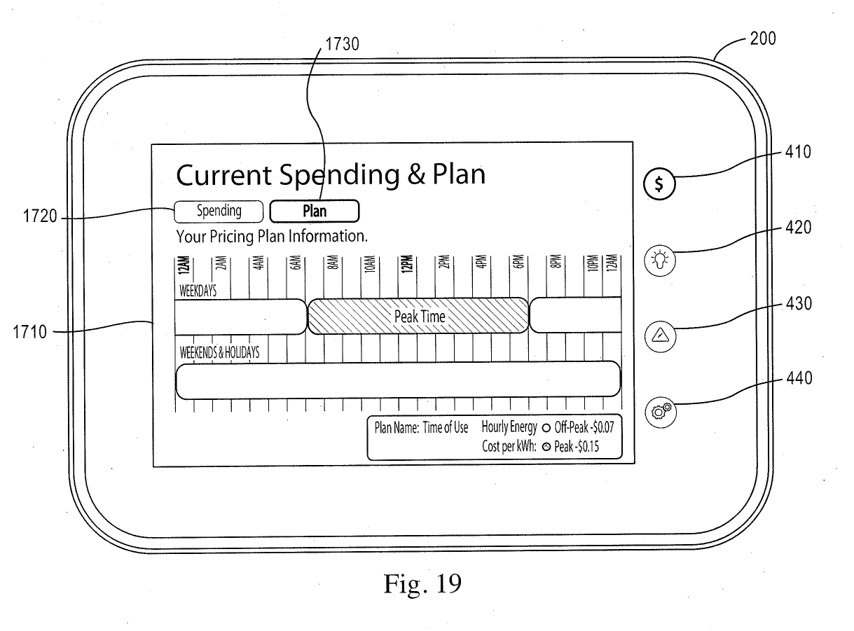

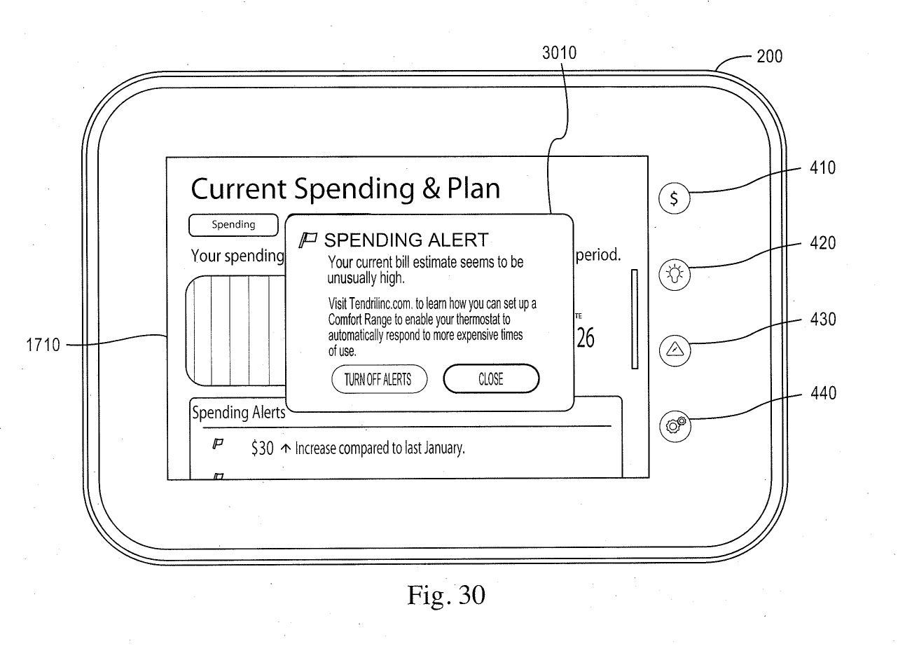

Turning to FIG. 17, an embodiment can include a spending icon 410 that, when activated, can display a spending plan interface 1710 that allows an energy consumer to manage their energy spending with further activation elements. The embodiment of FIG. 17 shows two activation elements, a spending activation element 1720 and a spending plan activation element 1730. Selecting the spending activation element 1720 can display current spending, billing estimates and spending alerts, as shown in FIGS. 17 and 18. Other embodiments can include other energy spending information. Selecting spending plan activation element 1730 can display spending plan information including peak energy cost and consumption times to assist the consumer in planning energy consumption as shown in FIG. 19. Spending alert 3010, as shown in FIG. 30, can be displayed after selection of an activation element with spending plan 1710, and can be similar to the spending alert 2810 discussed above.

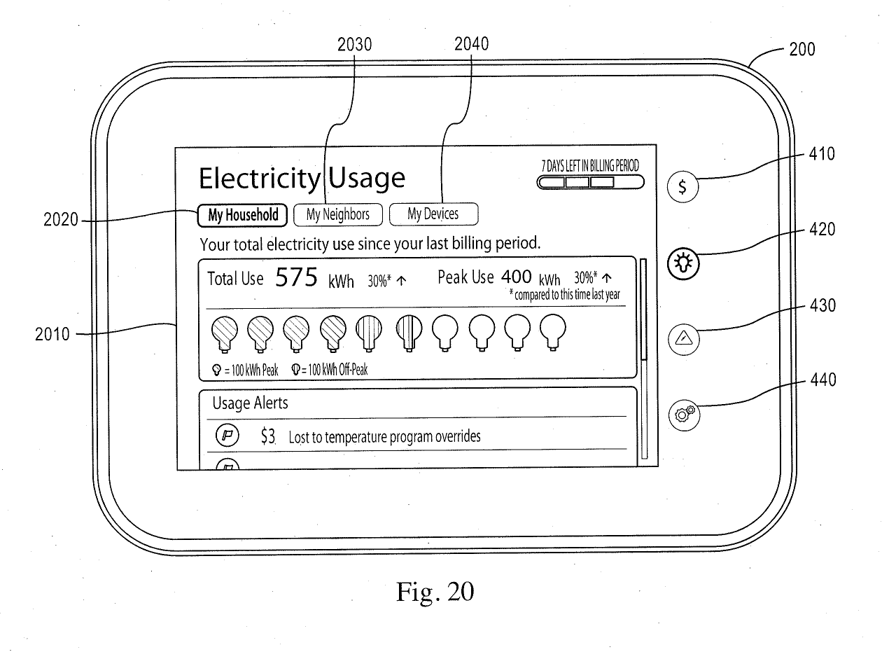

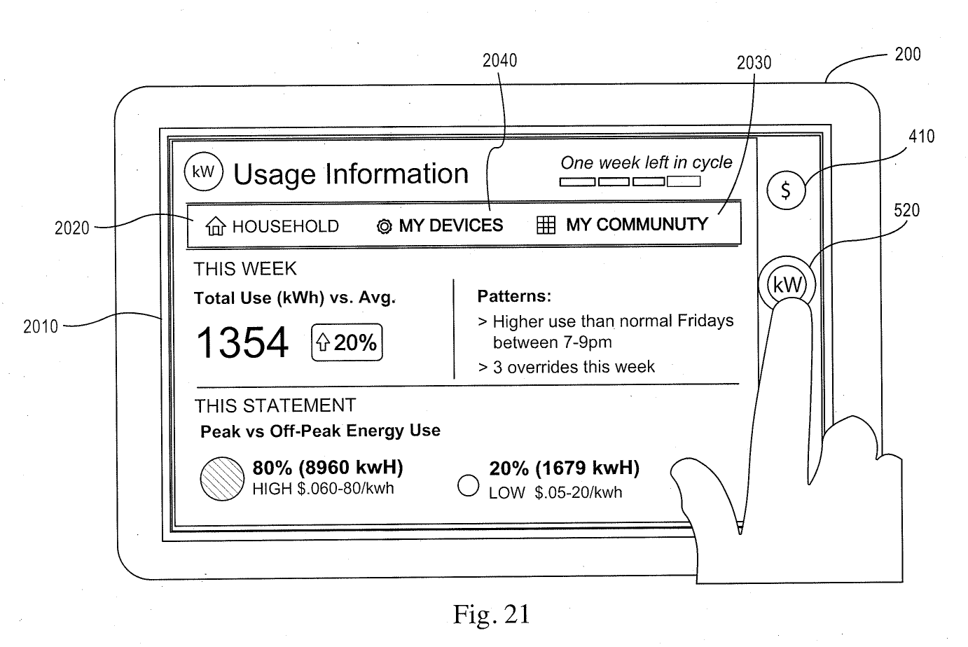

Referring now to FIG. 20, an embodiment is shown in which the device 200 can display energy usage information 2010. Such information can be displayed by the user selection of an activation element, such as the energy usage activation element icon 420 or energy usage activation element icon 520. Furthermore, selection of My Household activation element 2020 can also cause the display of energy usage information 2010. Energy usage information 2010 can also be displayed as a result of some other user action or condition. Energy usage information 2010 can include various information about energy use in the metered environment, including, without limitation, information about use in a current billing period or across billing periods, for specific disaggregated circuit elements, or for particular types of uses. FIG. 21 illustrates another embodiment that includes the energy usage information 2010 for the metered environment

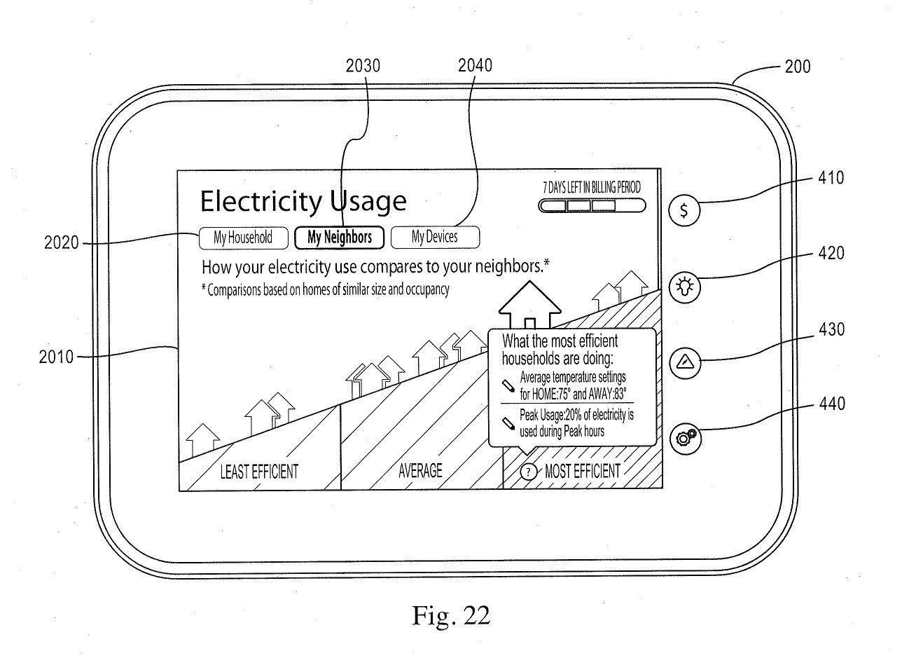

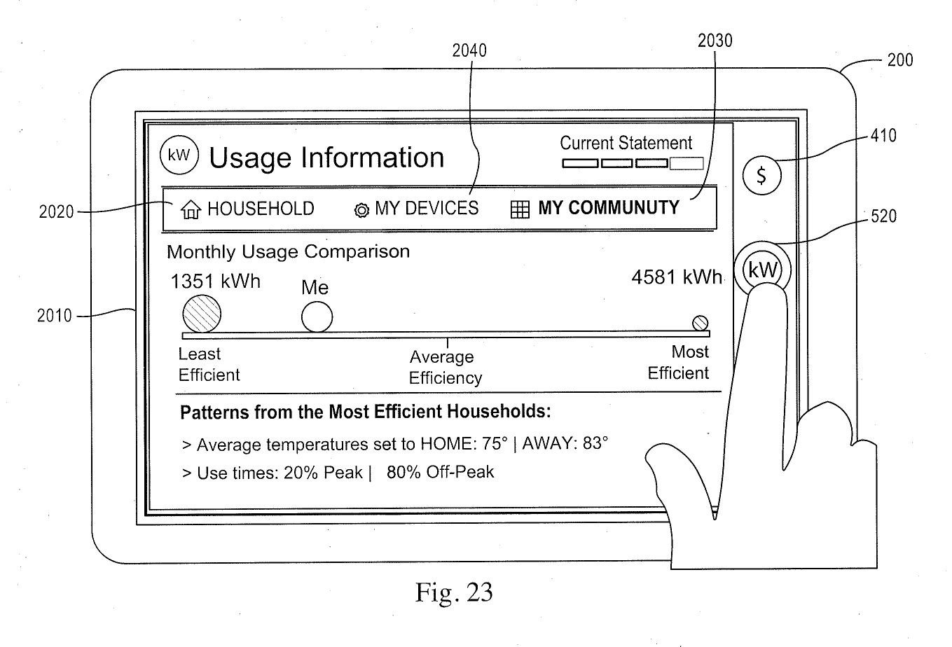

FIG. 22 is an embodiment including energy usage related to metered environment similar in some respect to the user's metered environment. Specifically, the embodiment of FIG. 22 provides information about how the energy usage of the metered environment compares to that of similar or proximate metered environments. The energy usage information 2010 of FIG. 22 can be displayed via user selection of the My Neighbors or My Community activation element 2030. In other embodiments, display of this usage information can be caused by activation of some other display element or some other condition. FIG. 23 is yet another embodiment of information similar to that shown in FIG. 22.

Referring now to FIGS. 24 and 25, an embodiment is shown in which energy usage information 2010 is detailed for disaggregated circuit elements. This type of energy usage information 2010 can be displayed as a result of selection of the My Devices activation element 2040. Likewise, as yet another illustration of the successive nature of the display 210 and activation elements, the information of FIGS. 24 and 25 could be displayed as a result of user selection of an orb segment 1310-1340, 1510, or some other activation element.

FIGS. 26 and 27, discussed above, similarly can be displayed by user selection of utility provider activation element icons 430, 530 and settings activation element icons 440, 450, respectively, with settings activation element 2720 and preference activation element 2730 leading to settings and preferences information, respectively.

In conclusion, the present invention provides, among other things, a method, apparatus, and system for programming and monitoring energy use and cost. Those skilled in the art can readily recognize that numerous variations and substitutions may be made in the invention, its use, and its configuration to achieve substantially the same results as achieved by the embodiments described herein. Accordingly there is no intention to limit the invention to the disclosed exemplary forms. Many variations, modifications, and alternative constructions fall within the scope and spirit of the disclosed invention as expressed in the claims.

What is claimed is:

1. A method, comprising:
displaying, on a display interface of a display device, a virtual analog clock;
receiving energy usage data for a metered environment;
displaying, on the face of the virtual analog clock, a graphical representation of a first level of the energy usage data, the graphical representation including at least one display element.

2. The method of claim 1, wherein the at least one display element includes an orb at the center of the virtual analog clock and at least one arc segment around the perimeter of the virtual analog clock.

3. The method of claim 2, wherein the orb includes a graphical representation of energy consumption data for the metered environment and the at least one arc segment includes a graphical representation of energy cost data for at least one time period for the metered environment.

4. The method of claim 3, wherein the at least one arc segment includes a first arc segment for a first time period that indicates an energy cost that is higher than a second energy cost indicated by a second arc segment for a second time period.

5. The method of claim 2, wherein the at least one display element includes graphical coding including at least one of color-coding, size-coding, brightness-coding, shape-coding, outline-coding, and icon-coding.

6. The method of claim 1, further comprising:
accepting, from a user, a request to display the graphical representation of the first level of the energy usage data; and
wherein the graphical representation of the first level of the energy usage data is displayed in response to the request.

7. The method of claim 6, further comprising:
entering a passive mode of the display interface, the entering the passive mode including dimming at least one of the display elements on the display interface.

8. The method of claim 1, wherein the graphical representation of the first level of the energy usage data is displayed in response to a predetermined threshold of energy usage.

9. The method of claim 8, wherein the threshold of energy usage is based at least in part on past energy consumption data for the metered environment.

10. The method of claim 1, wherein the graphical representation of the first level of the energy usage data includes a graphical representation of overall energy consumption for the metered environment.

11. The method of claim 1, further comprising:
accepting, from a user, a request to display a graphical representation of a second level of the energy usage data; and
displaying the graphical representation of the second level of the energy usage data.

12. The method of claim 11, wherein the accepting the request includes receiving the request at a display element of the graphical representation of the energy usage data.

13. The method of claim 11, wherein the graphical representation of the second level of the energy usage data includes a graphical representation of energy usage data for at least one disaggregated circuit element.

14. The method of claim 11, further comprising:
accepting, from a user, a request to remove the graphical representation of the second level of the energy usage data; and
removing the graphical representation of the second level of the energy usage data from the display interface.

15. An apparatus, comprising:
a processor;
a network interface to receive energy usage data for a metered environment; and
a display interface to display a virtual analog clock and a graphical representation of a first level of the energy usage data for the metered environment, the graphical representation of the first level of the energy usage data displayed on the face of the virtual analog clock and wherein the graphical representation includes at least one display element.

16. The apparatus of claim 15, wherein the at least one display element includes an orb at the center of the virtual analog clock and at least one arc segment around the perimeter of the virtual analog clock.

17. The apparatus of claim 16, wherein the at least one display element includes graphical coding including at least one of color-coding, size-coding, brightness-coding, shape-coding, outline-coding, and icon-coding.

18. The apparatus of claim 15, wherein the display interface includes a passive mode and an active mode.

19. The apparatus of claim 15, wherein the display interface is a touch-screen interface to accept a user request to display a graphical representation of energy usage data.

20. The apparatus of claim 19, wherein the virtual analog clock is a user-interface activation element of the touch-screen interface.

21. The apparatus of claim 20, wherein the orb displays energy consumption data and the at least one arc segment includes a first arc segment for a first time period that indicates an energy cost that is higher than a second energy cost indicated by a second arc segment for a second time period

22. The apparatus of claim 15, wherein the display interface displays a graphical representation of a second level of the energy usage data for the metered environment, the graphical representation of the second level of the energy usage data including a graphical representation of energy usage data for at least one disaggregated circuit element.

23. A system, comprising:
a display device to display a virtual analog clock and a graphical representation of a first level of energy usage data of a metered environment, wherein the display device includes at least one input port to accept the energy usage data for the metered environment, the graphical representation of the first level of the energy usage data being displayed on the face of the virtual analog clock and including at least one display element; and
at least one metering device associated with a disaggregated circuit element, wherein the at least one input port receives energy usage data for the disaggregated circuit element from the at least one metering device, and wherein the first level of the energy usage data includes the energy usage data of the disaggregated circuit element.

24. The system of claim 23, wherein the graphical representation includes at least one display element, the at least one display element includes an orb at the center of the virtual analog clock and at least one arc segment around the perimeter of the virtual analog clock.

25. The system of claim 24, wherein the at least one display element includes graphical coding including at least one of color-coding, size-coding, brightness-coding, shape-coding, outline-coding, and icon-coding.

26. The system of claim 23, wherein the display interface includes a passive mode and an active mode.

27. The system of claim 23, wherein the display device includes a touch-screen interface to accept a user request to display a graphical representation of energy usage data.

28. The system of claim 27, wherein the virtual analog clock is a user-interface activation element of the touch-screen interface.

29. The system of claim 28, wherein the orb displays energy consumption data and the at least one arc segment includes a first arc segment for a first time period that indicates an energy cost that is higher than a second energy cost indicated by a second arc segment for a second time period.

30. The apparatus of claim 23, wherein the display device displays a graphical representation of a second level of the energy usage data for the metered environment, the graphical representation of the second level of the energy usage data including a graphical representation of energy usage data for the disaggregated circuit element.
